(19) United States
(12) Patent Application Publication
(10) Pub. No.: US 2009/0248945 A1
(43) Pub. Date: Oct. 1, 2009

(54) NOISE REDUCING METHODS AND CIRCUITS

(76) Inventors: Navindra Navaratnam, Ipoh (MY); Edward Burton, Hillsboro, OR (US); Mahadev Nemani, Hillsboro, OR (US); Yanmei Tian, Sunnyvale, CA (US); Harry Muljono, San Ramon, CA (US)

Correspondence Address: INTEL CORPORATION;c/o CPA Global, P.O. BOX 52050, MINNEAPOLIS, MN, 55402, US

(21) Appl. No.: 12/059,158

(22) Filed: Mar. 31, 2008

(51) Int. Cl. G06F 13/00; H04L 27/00

(52) U.S. Cl. 710/316; 375/295

(57) ABSTRACT

In some embodiments, a circuit is provided with a transmitter to generate switching noise during clock events when no transition occurs to reduce data dependent switching noise.

### BACKGROUND

FIG. 1 shows a portion of a conventional data link for bi-directional communication between first and second agents 101A, 101B (e.g., chips such as processors, chipsets, memory, interface bridges, and any other chips). The depicted link includes N (e.g., 20) point-to-point interconnects (lanes) and a forwarded clock for each direction. The link portion for conveying data from Agent A to Agent B has N data transmitters 105A, a clock transmitter 115A, N data receivers 125B, and a clock receiver 135B coupled through channels 122 and 124 to transmit data from Agent A to Agent B. Likewise, the link from Agent B to Agent A has N data transmitter circuits 105B, a clock transmitter 115B, N data receivers 125A, and a clock receiver 135A coupled as shown to channels 113 and 118 for data transmission from Agent B to Agent A. There is also a system clock 121 and phase locked loop (PLL) circuits 119A, B to provide a clock to the data and clock forwarding transmitters 105, 115, respectively.

In the depicted scheme, the data is “double-pumped,” which means that data bits are transmitted on both the rising and falling edges of a clock, thereby effectively doubling the data bit rate. Each data transmitter 105 has flops 111, 112 coupled to feed data bits from a data source (e.g., read FIFO) through a 2:1 multiplexer 109 to a differential output driver 107 (e.g., a current mode driver to generate a differential voltage across termination resistors, not shown). (Note that for simplicity sake, the output drivers are represented simply using driver block symbols. Skilled persons will appreciate, however, that actual implementations may include other blocks such as transmitter equalization circuitry, finite state machine and other non-timing critical logic, as well as more time critical circuits such as transmitter serializers, pre-driver blocks, and/or current-steering current-mode digital-to-analog converter circuits. In some embodiments, such timing critical circuits may be supplied with a separate supply such as a filtered analog supply.) The clocks for the flops are provided from a PLL 119, which also feeds a single-ended to differential buffer 116 to provide the clock to an output clock driver 117 in each clock transmitter 115 to be forwarded to an associated receiver.

The clock receivers 135 comprise a differential receiver 137 to receive the clock from an associated clock transmitter. The receiver 137 provides the received clock to a delay locked loop (DLL) 139, which typically provides the clock at two or more different delay values (as dictated by control circuitry, not shown) to its associated N data receivers.

Each data receiver 125 has a differential receiver 127, a phase interpolator circuit (PI) 129, and a sampling latch 131. A transmitted data signal is received by the receiver 127, which provides it to the latch in a suitable form. The latch samples (or captures) a data value in each data signal phase off of an edge of a clock that is generated by the PI 129. From here, it is transferred downstream into a suitable memory buffer and/or into other memory (not shown).

The phase of the PI generated clock is dictated by the clock phases provided to the PI from the DLL 139. During initialization or calibration, training sequences are transmitted from the transmitters in each agent to their associated receivers for among other reasons, to set the DLLs in order to sample the data sufficiently within the center of the data phase. This compensates for jitter due to factors such as process and temperature variations. Unfortunately, this calibration or training can be impaired due to non-ideal conditions such as when noise is generated in the transmitter. For example, simultaneous switching noise (SSN) may be generated within the transmitters when transitions occur at the same time over the several lanes in a link. To reduce the affects of noise, in some cases, separate supplies may be used for the more timing critical blocks in a transmitter. Unfortunately, however, this may not be practical or it may not be sufficient, e.g., to meet more ambitious jitter requirements. Accordingly, new solutions may be desired.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a diagram of a conventional inter-chip communication link.

FIG. 2 is a diagram of a portion of a transmitter with an activity generator in accordance with some embodiments.

FIG. 3 is a diagram of a portion of a transmitter in a double-pumped scheme with an activity generator in accordance with some embodiments.

FIG. 4 is a more detailed diagram of an activity generator circuit, suitable for use as the activity generator in FIG. 3, in accordance with some embodiments.

FIG. 5 is a timing diagram showing signals from the circuit of FIG. 4 in accordance with some embodiments.

FIG. 6 is a diagram showing staggered activity generation in a multiple lane link in accordance with some embodiments.

FIG. 7 shows a circuit for implementing staggered activity generation engagement in accordance with some embodiments.

FIG. 8 is a diagram of a computer system with links having activity generators in accordance with some embodiments.

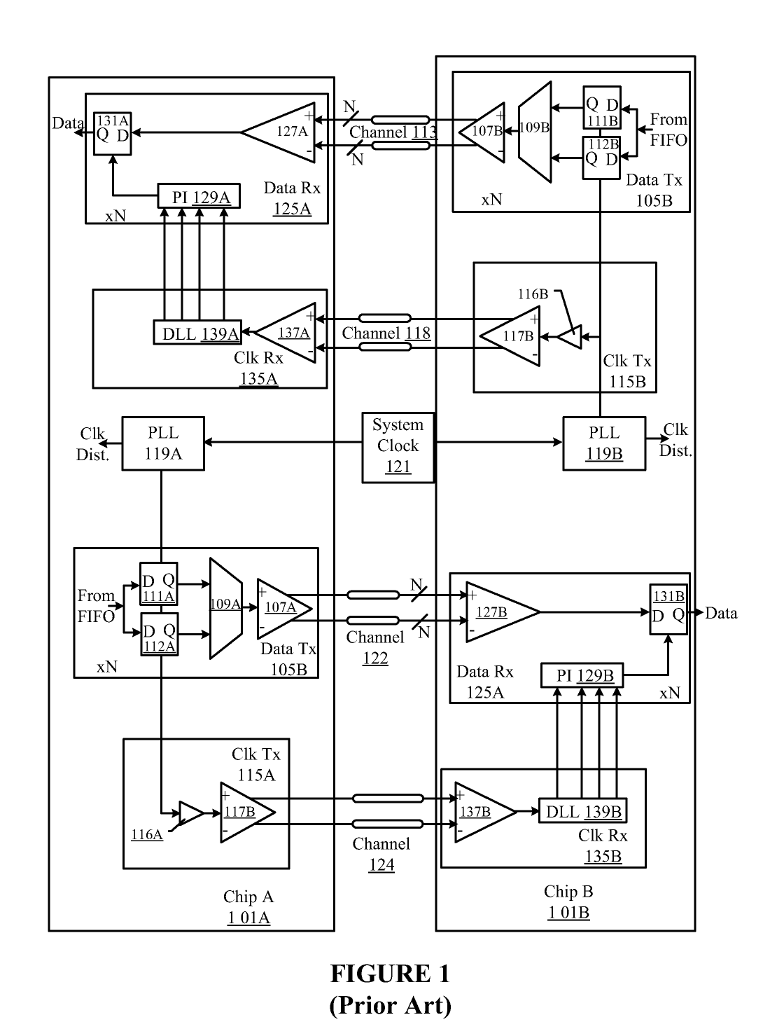

### DETAILED DESCRIPTION

It has been discovered that package resonance and other detrimental noise may be caused by data dependent transient switching at the transmitters. This problem may be exacerbated, for example, during training sequences when all of an agent's (or port's) transmitter lanes drive out the same training sequence data pattern simultaneously. (In some embodiments, a pseudo-random bit sequence may be used for the training sequence to reduce simultaneous switching noise during training, retraining, or idle periods, but the same, albeit pseudo random sequence, may still be used for each lane at the same time, which may result in excessive simultaneous switching noise, SSN.) Accordingly, to redress this and other problems, methods and circuits to mitigate against such data dependent noise are provided herein.

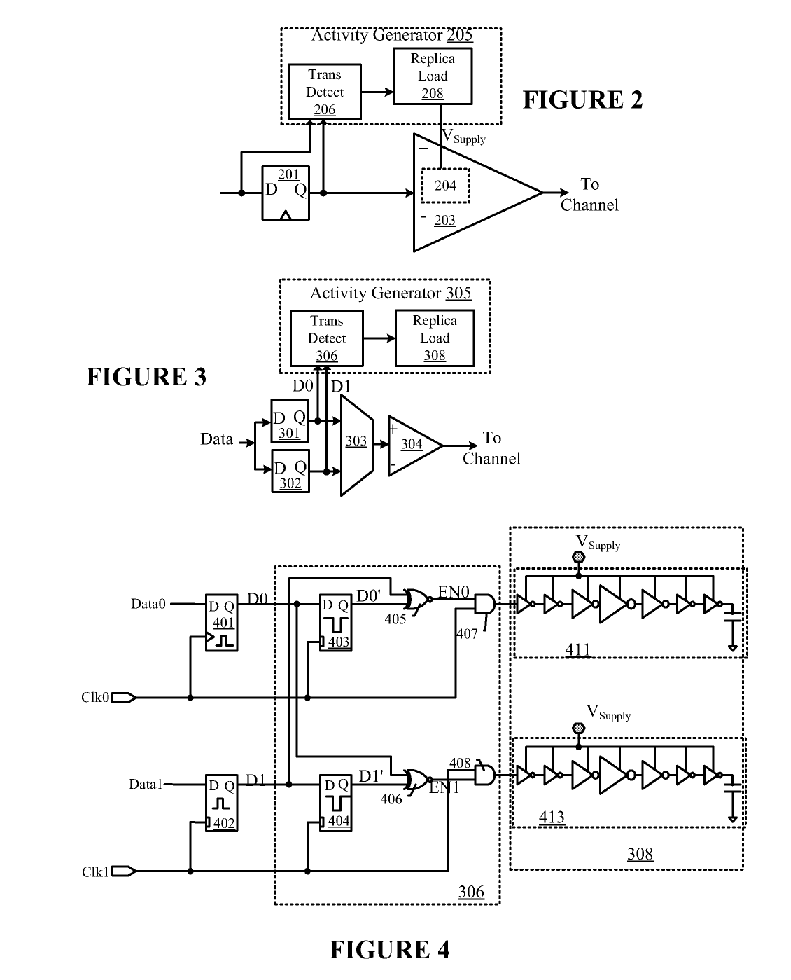

FIG. 2 generally shows a transmitter circuit with an activity generator to create comparable switching transients to cancel off data dependent frequency content. Shown in this figure is a transmitter 203 with a data supplying latch 201 to supply the transmitter with bits of data to be driven onto a channel. The transmitter 203 generally represents the various circuit blocks in a transmitter such as serializers, pre-drivers, and output line drivers, and the like. A hashed box 204 represents blocks within the transmitter identified as being problematic in generating data dependent noise. In this depiction, they include more timing critical blocks, e.g., transmitter serializers, pre-driver blocks, and/or current-steering current-mode digital-to-analog converter circuits, that are powered by a separate supply, V_{Supply}, from the rest of the transmitter.

An activity generator 305 is coupled to the transmitter and latch circuitry, as shown, to generate transients in the power supply, V_{Supply}, used or the identified transmitter portion 204 when a data transition would otherwise not occur on a clock event so that transients are periodically generated thereby making them data independent. (the term “clock event” refers to a time, usually periodic, when a data bit is to be transmitted out of a transmitter and onto a channel. it will usually coincide with a falling and/or rising edge of a clock used to “clock” data out of the transmitter.)

The activity generator 205 has a transition detector 206 to detect whether a transition will occur and a replica load 208 to sufficiently replicate transient characteristics of the identified transmitter portion 204. For each clock event, the transition detector 206 determines if a data transition will occur and if not, then it excites the replica load 208 for that clock event. Otherwise, data will transition naturally for the clock event. In this way, transients are generated for each clock event, and they are no longer data dependent. Essentially, the overall net effect is constant switching transients that have little or no data frequency content, regardless of the package resonance. This means that the activity generator can be effectively used with any package resonance frequency and be insensitive to resonance frequency shifts.

FIG. 3 shows an activity generator circuit 305 for use in a double-pumped transmitter circuit. The transmitter circuit has first and second phase latches 301, 302, respectively, coupled to a 2:1 multiplexer 303 to alternatively feed data bits to transmitter circuitry 304. The activity generator 305 comprises a transition detector 306 and a replica load 308, as discussed above, to create sufficiently replicating transients in the power supply used for the identified problematic transmitter portion during a clock event when a data transition does not occur.

FIG. 4 shows an activity generator with transition detector 306 and replica load 308 in accordance with a more specific embodiment. It's designed to work in a double-pumped scheme, with first and second clocks, Clk0 and Clk1, that are 180 degrees out-of-phase from each other. (they serve to “double-pump” the data without having to use both falling and rising edges in a single clock.)

The replica load 308 comprises first and second sets of tapered inverters 411 and 413. Each set is configured to sufficiently replicate at least the transient characteristics for the identified portion of the transmitter 304, and possibly multiplexer 303 as well. (Tapered inverters may be convenient but any suitable circuit, even the relevant transmitter circuit portions, could also be used for replica load(s)). The replica loads are powered by the same supply (V_{Supply}) that supplies the identified problematic transmitter portion. Thus, when either load is pulsed, it causes sufficiently similar dynamic switching noise as when a data transition actually occurs.

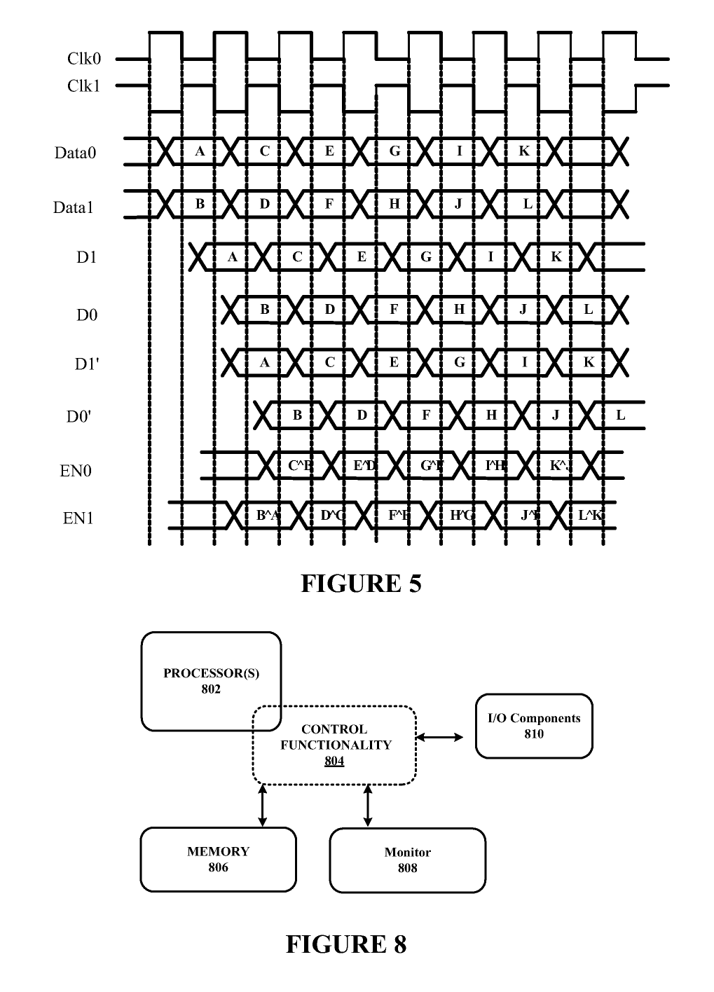

The transition detector 306 comprises latches 403, 404, XNOR gates 405, 406, and AND gates 407, 408, all coupled together as shown. FIG. 5 is a timing diagram showing signals identified in the figure.

In operation, D0 and D1 are alternatively provided to the output driver 304 by their respective clocks. The transition detector circuit is configured so that XNOR gate 406 compares a present D0 with a previous D1 and asserts if they are the same or de-asserts if they are not the same. Similarly, XNOR gate 405 compares a present D1 with a previous D0 and asserts if they are the same or de-asserts if they are not the same. Thus, for every clock event, if no data transition occurs, one of the two XNOR gates will assert. Each is coupled to an AND gate (407, 408), which serves to synchronize the assertion from its XNOR gate with the appropriate clock. Thus, the assertion (indicative of no data transition) causes one of the replica loads (411 or 413) to be excited.

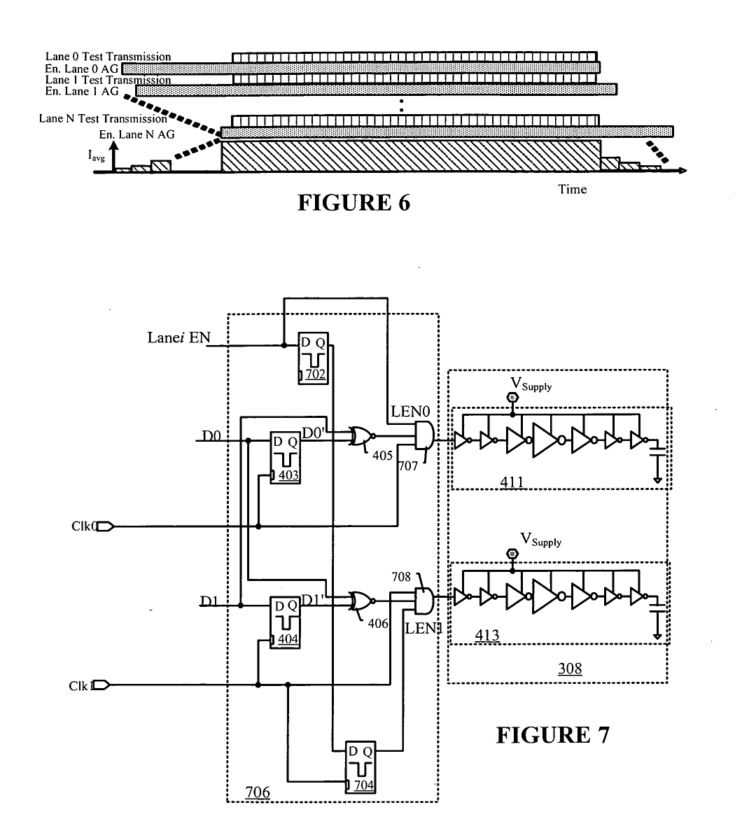

With reference to FIGS. 6-7, additional embodiments are shown. They may further reduce switching noise when multiple lanes are used in a link. With some conventional schemes, the training (e.g., using pseudo random sequences, the same for each lane) are staggered to reduce the magnitude of the switching noise due to the compound effects of the multiple lanes switching at the same time. Unfortunately, however, with this approach, excessive delay is required for training a link. Accordingly, the embodiment of FIGS. 6 and 7 addresses this issue.

As shown in FIG. 6, the training sequences may be enabled close to (if not at) the same time for the lanes, but activity generation, as discussed above, is used and enabled on a staggered basis. This results in reduced simultaneous switching noise without having to excessively delay training for all of the lanes.

FIG. 7 shows an activity generator circuit that may be used for each lane in accordance with some embodiments. it corresponds to the activity generator circuit of FIG. 4 except that it includes an extra input for each AND gate to receive enable signals (LEN0 and LEN1) by way of latches 702 and 704 from a lane enable signal (Lanei EN) for a given lane. Control circuitry controls a Lanei EN signal for each lane in a link to progressively assert the signal and thereby enable its activity generation from one or more lanes to the rest, e.g., as shown in FIG. 6, until all of the lanes in the link are enabled

With reference to FIG. 8, one example of a portion of a computer platform (e.g., computing system such as a mobile personal computer, server, or the like) is shown. The represented portion comprises one or more processors 802, interface control functionality 804, memory 806, monitor 808, and I/O components 810. The processor(s) 802 is coupled to the memory 806, monitor 808, and I/O components (e.g., keyboard, mouse, interface, etc.) through control functionality 804. The control functionality may comprise one or more circuit blocks to perform various interface control functions (e.g., memory control, graphics control, I/O interface control, and the like. These circuits may be implemented on one or more separate chips and/or may be partially or wholly integrated within the processor(s) 802.

The memory 806 comprises one or more memory blocks to provide additional random access memory to the processor(s) 802. It may be implemented with any suitable memory including but not limited to dynamic random access memory, static random access memory, flash memory, or the like. In some embodiments, one or more of the memory 806, control functionality 804, and I/O components comprise links to establish interconnections with transmitters having activity generation as discussed herein.

In the preceding description, numerous specific details have been set forth. However, it is understood that embodiments of the invention may be practiced without these specific details. In other instances, well-known circuits, structures and techniques may have not been shown in detail in order not to obscure an understanding of the description. With this in mind, references to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the preceding description and following claims, the following terms should be construed as follows: The terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

It should also be appreciated that in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

It should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS, for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. A chip, comprising:
a transmitter to drive bits onto a channel; and
an activity generator coupled to the transmitter, the activity generator having a replica load that is powered by a supply common with at least a portion of the transmitter, the replica load to be excited during a clock event at least for a training mode when a data transition in the transmitter does not occur.

2. The chip of claim 1, in which the replica load comprises two or more separate replica load circuits.

3. The chip of claim 1, in which the replica load models the transient characteristics of the at least a portion of the transmitter.

4. The chip of claim 1, in which the at least a portion of the transistor comprises time critical blocks powered by an analog power supply that is separate from a different power supply powering other less time critical blocks in the transmitter.

5. The chip of claim 1, in which the activity generator comprises a transition detector to compare adjacent bits to be transmitted over the transmitter.

6. The chip of claim 1, in which the replica load comprises a plurality of tapered inverter circuits.

7. The chip of claim 1, in which the bits are driven through the transmitter in a double-pumped fashion.

8. An apparatus, comprising:
a transmitter to transmit a bit stream; and
a generator circuit to generate switching noise when a non-transitioning bit is to be transmitted.

9. The apparatus of claim 8, in which the generator circuit has a replica load to generate the switching noise.

10. The apparatus of claim 9, in which the replica load models transient characteristics of a portion of the transmitter.

11. The apparatus of claim 10, in which the replica load comprises one or more inverters.

12. The apparatus of claim 10, in which the transmitter portion is powered by a separate supply than other parts of the transmitter.

13. The apparatus of claim 8, in which the generator circuit comprises a transition detector with one or more gates to compare adjacent bits in the bit stream.

14. The apparatus of claim 8, in which the transmitter is part of multiple transmitter in a link, wherein the generator circuits for the different transmitter are enabled on a staggered basis.

15. An apparatus, comprising:
a plurality of transmitters to be part of a link; and
a generator circuit associated with each transmitter to generate switching noise in its associated transmitter at least during a training mode when a non-transitioning bit is to be transmitted, wherein generator circuits for different transmitters are enabled at different times.

16. The apparatus of claim 15, in which the generator circuits each comprise a replica load to suitably replicate transient characteristics of a relevant portion of its associated transmitter.

17. The apparatus of claim 16, in which pseudo random bits are to be transmitted during the training mode.

18. A computer system, comprising:
a processor chip and an interface control chip to be coupled together through one or more links comprising a multiplicity of transmitters in each chip, wherein each transmitter has a generator circuit to generate for the transmitter switching noise when a non-transitioning bit is to be transmitted through the transmitter at least during a training mode; and
a monitor to be coupled to the processor through the interface control chip.
